(19) United States
(12) Patent Application Publication
(10) Pub. No.: US 2016/0129620 A1
(43) Pub. Date: May 12, 2016

(54) MOLDING MACHINE CROSSHEAD AND PARISON FORMING METHOD USING SAME

(71) Applicant: THE JAPAN STEEL WORKS, LTD., Tokyo (JP)

(72) Inventors: Ryuichi KAWACHI, Kanagawa (JP); Yuji ITO, Kanagawa (JP); Toshinari TAKEYAMA, Kanagawa (JP); Yukio FUJIWARA, Kanagawa (JP)

(21) Appl. No.: 14/896,499

(22) PCT Filed: Jul. 14, 2014
(86) PCT No.: PCT/JP2014/068689

§ 371 Date: Dec. 7, 2015

(30) Foreign Application Priority Data
Aug. 2, 2013 (JP) 2013-161041

(51) Int. Cl. B29C 47/28; B29C 47/08; B29B 11/10; B29C 47/06; B29C 47/56; B29C 49/04; B29C 47/00

(52) U.S. Cl. CPC B29C 47/28; B29C 49/04; B29C 47/0816; B29C 47/0023; B29C 47/062; B29C 47/56; B29B 11/10; B29K 2995/0005

(57) ABSTRACT

The present invention provides a molding machine crosshead which uses one additional resin extruder and one base resin extruder that are connected to one annular flow channel of a crosshead unit at mutually different angular positions and which is configured to form a parison by adding an additional layer constituted by an additional resin from the additional resin extruder to a base layer constituted by a base resin supplied from the base resin extruder into the annular flow channel, the additional resin being a material different from the base resin, wherein the additional resin is formed in a linear shape along the longitudinal direction of the parison as part of the parison.

### TECHNICAL FIELD

The present invention relates to a molding machine crosshead and a parison forming method using the same, and more particularly to a novel improvement for supplying a base resin and an additional resin from a plurality of extruders into an annular flow channel of a crosshead unit and forming the additional resin in a line shape in part of a parison.

### BACKGROUND ART

A large number of molding machine crossheads of this type, including those for single-layer parisons and those for multilayer parisons, have been conventionally used.

Further, configurations that add functional layers have been also used to impart necessary functionality (for example, gas barrier property and water absorption property) to the crossheads for multilayer parisons.

Furthermore, a method for special processing of a die and a method for manufacturing a multilayer container having a stripe pattern, which has been proposed in Patent Literature 1, are known as molding methods for inserting different resins.

Patent Literature 1: Japanese Patent Application Publication No. S54-53087.

Since the conventional molding machine crosshead has the above-described configuration, the following problems are associated therewith.

Thus, in the conventional molding machine crosshead, one or more layers of a functional resin need to be added to impart functionality. However, depending on the required functionality, it is not always necessary to provide the functional resin over the entire circumferential direction of a parison, and sometimes the functional resin may be provided only in part in the circumferential direction, that is, in a linear shape in the parison flow direction. For example, the case, in which a molded article is imparted with electric conductivity can be considered. Since functional resins are most often more expensive than general-use resins, where the functional resin layer is added over the entire circumferential direction when it is not needed over the entire circumferential direction of the parison and may be provided only in part in the circumferential direction, that is, in a linear shape in the parison flow direction, the cost of functionality rises unnecessarily and cost-efficient utility is difficult to achieve.

Further, a die can be subjected to special processing, or a functional resin can be inserted linearly by the method proposed in Patent Document 1. However, in the former case, a single-layer parison structure cannot be obtained, and even in a multilayer structure, the functional resin cannot be inserted into the inner layer or intermediate layer. Furthermore, the line width is restricted by functional limitations. In the latter case, the functional resin cannot be inserted into the outer layer and intermediate layer in a multilayer configuration. The additional processing with a T-shaped adapter is needed to change the line width.

### DISCLOSURE OF THE INVENTION

The present invention has been created to resolve the above-described conventional problems. In particular, it is an objective of the present invention to provide a molding machine crosshead and a parison forming method using the same that make it possible to add effectively the necessary amount of an additional resin (functional resin) to a base resin (mainly, a general-use resin) in a linear shape in a parison flow direction by providing a merging section for the additional resin in a merging portion obtained during the circumferential spread of the base resin inside the crosshead.

The present invention provides a molding machine crosshead which uses at least one additional resin extruder and at least one base resin extruder that are connected to at least one annular flow channel of a crosshead unit at mutually different angular positions and which is configured to form a parison by adding an additional layer constituted by an additional resin from the additional resin extruder to a base layer constituted by a base resin supplied from the base resin extruder into the annular flow channel, the additional resin being a material different from the base resin, wherein the additional resin is formed in a linear shape along a longitudinal direction of the parison as part of the parison by forming a merging section of the additional resin in a merging portion obtained during a circumferential spread of the base resin inside the annular flow channel. In the molding machine crosshead, the additional resin is an electrically conductive resin. In the molding machine crosshead, an insertion angle, on a circumference inside the annular flow channel, of the additional resin into the base resin can be freely changed by adjusting extrusion amounts from the extruders. In the molding machine crosshead, as a result of merging the additional resin in a portion with a lowest flow velocity which is the merging section obtained during the circumferential spread of the base resin inside the annular flow channel, a difference in flow velocity distribution inside the crosshead unit is reduced and a resin replacement time is shortened compared with when using a configuration in which a resin is supplied to the crosshead unit with only one extruder. In the molding machine crosshead, as a result of merging the additional resin in a portion with a lowest flow velocity which is the merging section obtained during the circumferential spread of the base resin inside the annular flow channel, a difference in flow velocity distribution inside the crosshead unit is reduced and parison thickness unevenness in the circumferential direction is decreased compared with when using a configuration in which a resin is supplied to the crosshead unit with only one extruder. In the molding machine crosshead, the additional resin extruder and the base resin extruder are connected to the annular flow channel at positions which are arranged opposite each other with an angular separation of 180 degrees. In the molding machine crosshead, a plurality of the annular flow channels is formed concentrically, a plurality of the additional resin extruders and a plurality of the base resin extruders are connected to the crosshead unit, and the parison having the base layer formed as multiple layers and the additional layer formed in the linear shape as multiple layers is obtained. In the molding machine crosshead, when the multilayer parison is formed using the plurality of annular flow channels provided in the crosshead unit, an insertion angle of the additional resin in the annular flow channels can be freely changed by changing an attachment angle, on the circumference of the annular flow channels, of sleeves provided between housings and an inner core of the crosshead unit. In the molding machine crosshead, end surfaces of the additional layer of the additional resin formed within the insertion angle are, in a cross-sectional view, in a direction same as a radial direction of the parison, inner side portions and outer side portions of the end surfaces match an inner circumferential surface and an outer circumferential surface of the base layer of the base resin of the parison, and the additional layer is not present in the base layer outside the end surfaces of the additional layer. The present invention also provides a parison manufacturing method using a molding machine crosshead which uses at least one additional resin extruder and at least one base resin extruder that are connected to at least one annular flow channel of a crosshead unit at mutually different angular positions and which is configured to form a parison by adding an additional layer constituted by an additional resin from the additional resin extruder to a base layer constituted by a base resin supplied from the base resin extruder into the annular flow channel, the additional resin being a material different from the base resin, the method including forming the additional resin in a linear shape along a longitudinal direction of the parison as part of the parison by forming a merging section of the additional resin in a merging portion obtained during a circumferential spread of the base resin inside the annular flow channel. In the parison manufacturing method, the additional resin is an electrically conductive resin. In the parison manufacturing method, an insertion angle, on a circumference inside the annular flow channel, of the additional resin into the base resin can be freely changed by adjusting extrusion amounts from the extruders. In the parison manufacturing method, as a result of merging the additional resin in a portion with a lowest flow velocity which is the merging section obtained during the circumferential spread of the base resin inside the annular flow channel, a difference in flow velocity distribution inside the crosshead unit is reduced and a resin replacement time is shortened compared with when using a configuration in which a resin is supplied to the crosshead unit with only one extruder. In the parison manufacturing method, as a result of merging the additional resin in a portion with a lowest flow velocity which is the merging section obtained during the circumferential spread of the base resin inside the annular flow channel, a difference in flow velocity distribution inside the crosshead unit is reduced and parison thickness unevenness in the circumferential direction is decreased compared with when using a configuration in which a resin is supplied to the crosshead unit with only one extruder. In the parison manufacturing method, the additional resin extruder and the base resin extruder are connected to the annular flow channel at positions which are arranged opposite each other with an angular separation of 180 degrees. In the parison manufacturing method, a plurality of the annular flow channels is formed concentrically, a plurality of the additional resin extruders and a plurality of the base resin extruders are connected to the crosshead unit, and the parison having the base layer formed as multiple layers and the additional layer formed in the linear shape as multiple layers is obtained. In the parison manufacturing method, when the multilayer parison is formed using the plurality of annular flow channels provided in the crosshead unit, an insertion angle of the additional resin in the annular flow channels can be freely changed by changing an attachment angle, on the circumference of the annular flow channels, of sleeves provided between housings and an inner core of the crosshead unit. In the parison manufacturing method, end surfaces of the additional layer of the additional resin formed within the insertion angle are, in a cross-sectional view, in a direction same as a radial direction of the parison, inner side portions and outer side portions of the end surfaces match an inner circumferential surface and an outer circumferential surface of the base layer of the base resin of the parison, and the additional layer is not present in the base layer outside the end surfaces of the additional layer.

Since the molding machine crosshead and the parison molding method using the same in accordance with the present invention have the above-described features, the following effects can be obtained.

Thus, in a molding machine crosshead which uses at least one additional resin extruder and at least one base resin extruder that are connected to at least one annular flow channel of a crosshead unit at mutually different angular positions and which is configured to form a parison by adding an additional layer constituted by an additional resin from the additional resin extruder to a base layer constituted by a base resin supplied from the base resin extruder into the annular flow channel, the additional resin being a material different from the base resin, the additional resin is formed in a linear shape along a longitudinal direction of the parison as part of the parison by forming a merging section of the additional resin in a merging portion obtained during a circumferential spread of the base resin inside the annular flow channel, thereby making it possible to form the additional resin by effectively adding the necessary amount of the additional resin to the base resin in a linear shape along the parison flow direction.

Since the additional resin is an electrically conductive resin, a functional resin can be formed linearly on a molded article produced from the parison.

Since the insertion angle, on a circumference inside the annular flow channel, of the additional resin into the base resin can be freely changed by adjusting extrusion amounts from the extruders, the width ratio can be steplessly varied.

As a result of merging the additional resin in a portion with a lowest flow velocity which is the merging section obtained during the circumferential spread of the base resin inside the annular flow channel, a difference in flow velocity distribution inside the crosshead unit is reduced and a resin replacement time can be shortened compared with when using a configuration in which a resin is supplied to the crosshead unit with only one extruder.

As a result of merging the additional resin in a portion with a lowest flow velocity which is the merging section obtained during the circumferential spread of the base resin inside the annular flow channel, a difference in flow velocity distribution inside the crosshead unit is reduced and parison thickness unevenness in the circumferential direction is decreased compared with when using a configuration in which a resin is supplied to the crosshead unit with only one extruder.

Since the additional resin extruder and the base resin extruder are connected to the annular flow channel at positions which are arranged opposite each other with an angular separation of 180 degrees, the merging portion obtained during a circumferential spread of the base resin into the merging portion can be formed at a position with an angular separation of 180 degrees, whereby the additional layer formed in the linear shape by the additional resin can be easily positioned.

Since a plurality of the annular flow channels is formed concentrically, a plurality of the additional resin extruders and a plurality of the base resin extruders are connected to the crosshead unit, and the parison having the base layer formed as multiple layers and the additional layer formed in the linear shape as multiple layers is obtained, it is possible to obtain a molded article having a plurality of additional layers.

When the multilayer parison is formed using the plurality of annular flow channels provided in the crosshead unit, an insertion angle of the additional resin in the annular flow channels can be freely changed by changing an attachment angle, on the circumference of the annular flow channels, of sleeves provided between housings and an inner core of the crosshead unit. As a result, the angular width of the additional resin in the circumferential direction can be freely changed, and the width of the linear additional resin can be changed.

Since end surfaces of the additional layer of the additional resin formed within the insertion angle are, in a cross-sectional view, in the direction same as the radial direction of the parison, inner side portions and outer side portions of the end surfaces match an inner circumferential surface and an outer circumferential surface of the base layer of the base resin of the parison, and the additional layer is not present in the base layer outside the end surfaces of the additional layer, it is possible to clarify the boundaries of the additional layer with the base layer, and to form efficiently the additional layer, which is constituted by an expensive resin, without unnecessary losses.

### BRIEF DESCRIPTION OF THE DRAWINGS

FIG. 1 is cross-sectional configuration diagram illustrating the molding machine crosshead in accordance with the present invention and the parison forming method using the same.

FIG. 2 is a configuration diagram illustrating the state of the annular flow channel depicted in FIG. 1.

FIG. 3 is a plan view of the parison formed with the annular flow channel depicted in FIG. 2.

FIG. 4 is a cross-sectional view illustrating another state depicted in FIG. 1.

FIG. 5 is an enlarged planar sectional view of the parison formed using the crosshead depicted in FIG. 4.

FIG. 6 is a perspective view of the molded article molded using the parison depicted in FIG. 3.

### BEST MODE FOR CARRYING OUT THE INVENTION

With the molding machine crosshead in accordance with the present invention and the parison forming method using the same, a base resin and an additional resin are supplied from a plurality of extruders into the annular flow channel of a crosshead unit and the additional resin is formed in a linear form in part of a parison.

The preferred embodiments of the molding machine crosshead and a parison forming method using the same in accordance with the present invention will be explained hereinbelow with reference to the drawings.

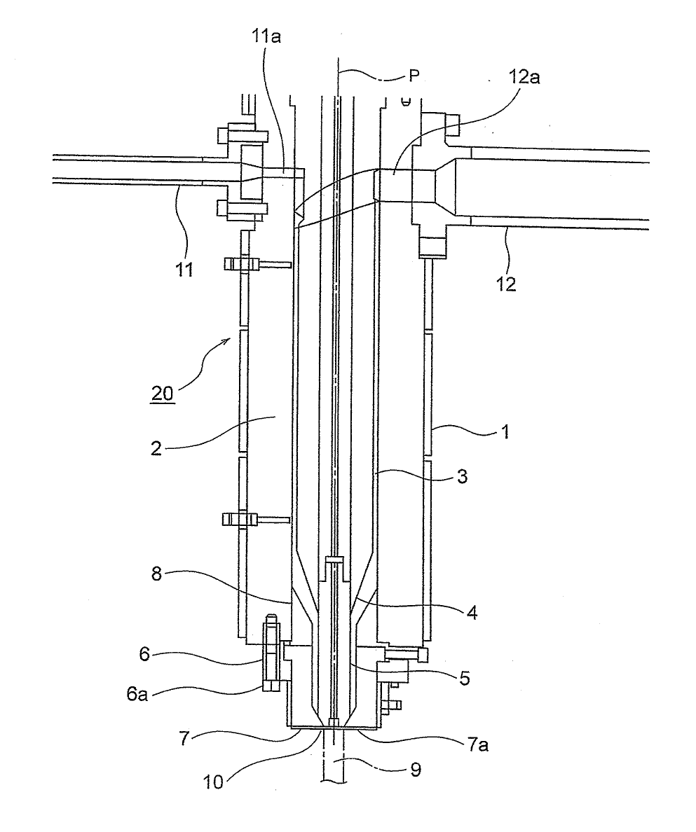

In FIG. 1, the reference numeral 1 denotes a crosshead unit. The crosshead unit 1 is constituted by a cylindrical thick-wall housing 2, an inner core 4 which is fixedly arranged on the inside of the housing 2, with an annular flow channel 3 being interposed therebetween, a round columnar core 5 provided in the lower portion of the inner core 4, a die 7 held by a die holder 6 which is fixed with a bolt 6a to the lower portion of the housing 2, a taper ring 8, positioned in the lower portion of the housing 2 and in the upper portion of the die 7, and a discharge port 10 constituted by a core gap which is formed by the core 5 and the die 7 at the lower end 7a of the die 7 and serves for discharging a cylindrical parison 9.

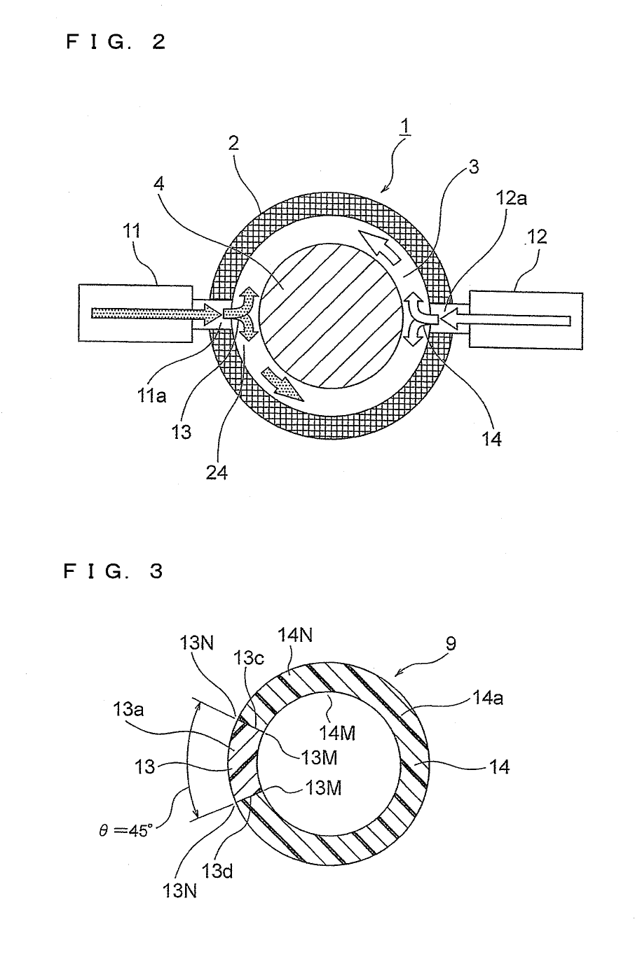

In the upper portion of the housing 2 of the crosshead unit 1, an additional resin extruder 11 and a base resin extruder 12 are arranged opposite each other with an angular separation of 180 degrees (as described hereinbelow, the two extruders can be arranged opposite each other with an angular separation other than 180 degrees) and configured as depicted in FIG. 2 in a plan view taken from an axial direction P of the crosshead unit 1.

The extrusion ports 11a and 12a at the tips of the extruders 11 and 12, respectively, are arranged to communicate with the annular flow channel 3 and configured such that a molten additional resin 13 extruded from the additional resin extruder 11 and a molten base resin 14 extruded from the extruded from the base resin extruder 12 are supplied into the annular flow channel 3 as depicted in FIG. 2.

A molding machine crosshead 20 using the above-described crosshead unit 1 depicted in FIGS. 1 and 2 is configured such that the molten base resin 14 extruded from the base resin extruder 12 spreads circumferentially along the annular flow channel 3, and the additional resin 13 extruded from the additional resin extruder 11 merges therewith in merging portions (positions close to the extrusion port 11a on the opposite side facing, with an angular separation of 180 degrees, the position of the base resin extruder 12) where merging occurs during the circumferential spread of the base resin 14.

FIG. 3 is a transverse sectional view of the parison 9 extruded using the crosshead unit 1 of the above-described molding machine crosshead 20, this view illustrating the forming process in which the insertion into the base resin 14 is performed in a range of about 45 degrees.

The extrusion amount ratio of the resins 13 and 14 in the aforementioned case is (base resin 14) : (additional resin 13) =7 : 3. Therefore, the line width which is the insertion angle θ of the additional resin 13, that is, the insertion angle θ, can be accurately controlled in a simple and accurate manner by the extrusion amount ratio of the base resin 14 and the additional resin 13.

The arrangement positions of the aforementioned extruders 11 and 12 are not limited to the configuration with a 180 degree angular separation therebetween, and the extruders can be arranged at angular positions with an angular separation other than 180 degrees.

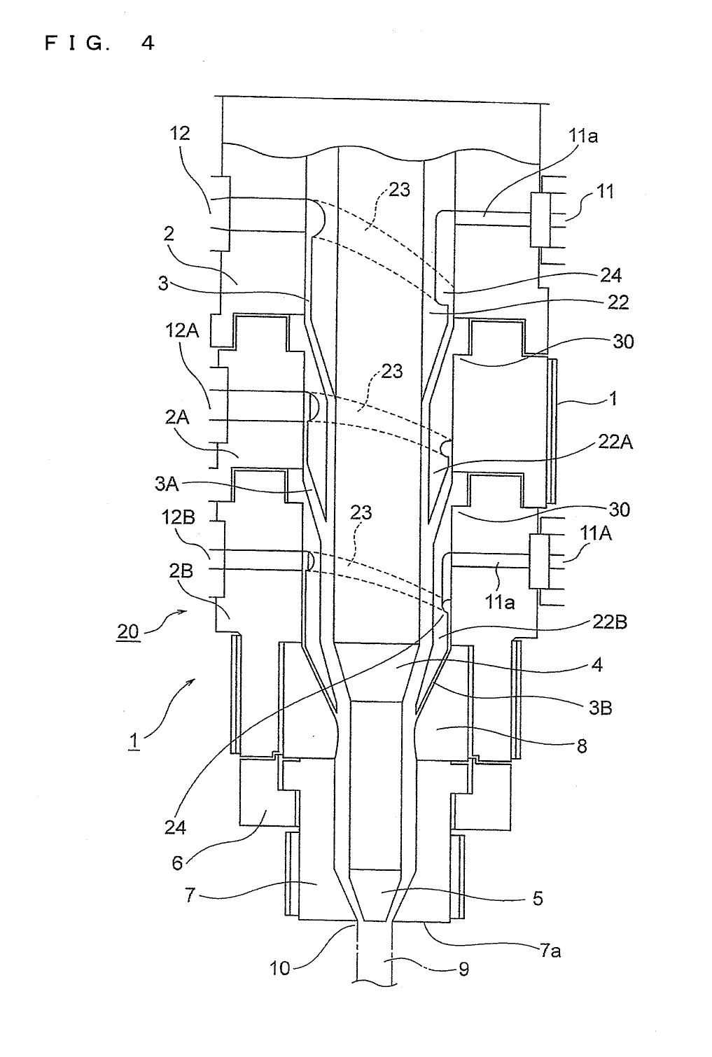

FIG. 4 illustrates a multilayer structure (a line of the additional resin 2 is inserted into the base resin 3) as another embodiment of the structure depicted in FIG. 1. The planar sectional view of the parison 9 in this case is depicted in FIG. 5.

Thus, the three-layer parison 9 is formed of the base resin 14, a linear additional resin 13 is inserted into part of the base resin 14, the linear additional resin 13 is inserted into part of the base resin 14, and a barrier layer 21 constituted by a well-known EVOH resin is provided in the base resin 14.

In the crosshead unit 1 in FIG. 4 which serves for extruding the aforementioned three-layer parison 9, the components same as those depicted in FIG. 1 are assigned with the same reference numerals and the explanation thereof is herein omitted. Only the components different from those depicted in FIG. 1 are explained.

The housing 2 depicted in FIG. 4 is configured of three stages, namely, the housing 2, a housing 2A, and a housing 2B in the top-down direction of the inner core 4, and base resin extruders 12, 12A, and 12B are individually connected to the housings 2, 2A, and 2B, respectively.

The housings 2 and 2B are provided with additional resin extruders 11 and 11A facing the base resin extruders 12 and 12 B, with an angular separation of 180 degrees therebetween.

A sleeve 22, a sleeve 22A, and a sleeve 22B are provided, to be rotatable in the left-right direction about the central axis of the inner core 4, at the outer circumference of the inner core 4 in the top-down direction thereof, with step-like engagement portions 30 of the housings 2, 2A, and 2B being interposed therebetween. The attachment angles of the housings 2, 2A, and 2B and the sleeves 22, 22A, and 22B can be changed by rotating the sleeves 22, 22A, and 22B. The insertion angle θ, that is, the line width, can be changed arbitrarily by changing the insertion position and insertion angle of the additional resin 13.

When the angle of attachment to the housings 2, 2A, and 2B is changed by rotating the sleeves 22, 22A, and 22B, the housings 2, 2A, and 2B depicted in FIG. 4 are removed, the sleeves 22, 22A, and 22b are then rotated to the left or right by using a jig (not depicted in the figure), and the desired insertion angle θ can be set for the additional resin 13 in a merging section 24 which is the merging portion for the additional resin 13 from the injection port 11a of the additional resin extruders 11, 11A and the base resin 14 injected from a flow channel 23 of the sleeves 22, 22B.

Therefore, in the configuration depicted in FIG. 4, the annular flow channel 3 connected to the base resin extruders 12, 12A, 12B is formed by three annular flow channels 3, 3A, and 3B, and the additional resin extruders 11, 11A are connected to the annular flow channels 3, 3B. Therefore, as depicted in FIG. 5, the parison 9 discharged from the discharge port 10 of the molding machine crosshead 20 depicted in FIG. 4 has a three-layer structure including, from the outer diameter side, the base resin 14, the base resin 14 having the barrier layer 21, and the base resin 14, and the additional resin 13 is formed within a range of the predetermined angle θ constituting part of the base resin 14.

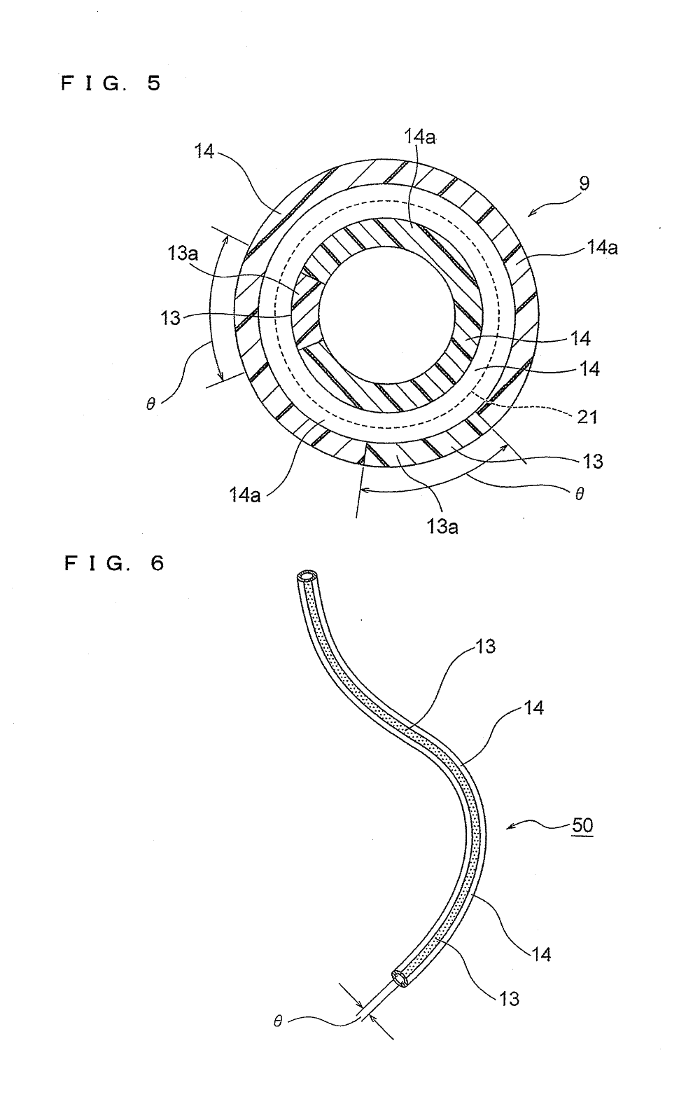

A molded article 50 obtained by molding the parison 9 depicted in FIG. 5 is not depicted in the figures, but where the molded article 50 is a product similar to the molded article 50 depicted in FIG. 6, two linear layers of the additional resin 13 are formed.

In FIG. 3, end surfaces 13c, 13d of the additional layer 13a of the additional resin 13 formed within the insertion angle θ are, in a cross-sectional view, in the direction same as the radial direction of the parison 9, inner side portions 13M and outer side portions 13N of the end surfaces 13c, 13d match an inner circumferential surface 14M and an outer circumferential surface 14N of the base layer 14a of the base resin 14 of the parison 9, and the additional layer 13a is not present in the base layer 14a outside the end surfaces 13c, 13d of the additional layer 13a.

Therefore, according to the present embodiment, in the molding process in which the additional resin 13 is added to the molten base resin 14 in the extruders 11, 11A, 12, 12A, and 12B in FIG. 4, the additional resin 13 can be added in a linear shape by providing the merging section 24 of the additional resin 13 in the merging portion obtained during the circumferential spread of the base resin 14 inside the crosshead unit 1. Further, the width ratio of the base resin 14 and the additional resin 13, that is, the insertion angle θ, can be steplessly varied, that is, changed, by each extrusion amount. Further, as a result of merging the additional resin 13 in the merging section 24, which is the merging portion obtained during the circumferential spread of the base resin 14, that is, in a portion with the lowest flow velocity, the difference in flow velocity distribution inside the crosshead unit 1 is reduced and a resin replacement time is shortened with respect to those when only one extruder is used as in the conventional configuration. Further, as a result of merging the additional resin 13 in the merging section 24, which is the merging portion obtained during the circumferential spread of the base resin 14, that is, in a portion with the lowest flow velocity, the difference in flow velocity distribution inside the crosshead unit 1 is reduced and parison thickness unevenness in the circumferential direction is decreased with respect to those when only one extruder is used as in the conventional configuration. In a molding machine crosshead 20 of a multilayer structure, as depicted in FIG. 4, the three-layer parison 9 is obtained with such a configuration, but the additional resin 13 can be added in a linear shape to an arbitrary layer among the arbitrary number of layers. Further, in the molding machine crosshead 20 of a multilayer structure, the insertion angle θ of the additional resin 13 can be arbitrarily changed by changing the attachment angle of the housings 2, 2A, and 2B and the sleeves 22, 22A, and 22B. Further, since the additional layer 13a is not present inside the base layer 14a outside the end surfaces 13c, 13d of the additional layer 13a, as depicted in FIG. 3, the boundaries of the linear additional layer can be clarified. In the explanation above, the crosshead unit 1 is arranged vertically, but it can be also arranged transversely.

Essentials of the molding machine crosshead and the parison forming method using the same in accordance with the present invention are summarized below.

Thus, with the configuration and method in accordance with the present invention, there is provided a molding machine crosshead which uses at least one additional resin extruder 11 and at least one base resin extruder 12 that are connected to at least one annular flow channel 3 of a crosshead unit 1 at mutually different angular positions and which is configured to form a parison 9 by adding an additional layer 13a constituted by an additional resin 13 from the additional resin extruder 11 to the base layer 14a constituted by a base resin 14 supplied from the base resin extruder 12 into the annular flow channel 3, the additional resin 13 being a material different from the base resin 14, wherein the additional resin 13 is formed in a linear shape along a longitudinal direction of the parison 9 as part of the parison 9 by forming a merging section 24 of the additional resin 13 in a merging portion obtained during a circumferential spread of the base resin 14 inside the annular flow channel 3. With the configuration and method, the additional resin 13 is an electrically conductive resin. With the configuration and method, an insertion angle θ, on a circumference inside the annular flow channel 3, of the additional resin 13 into the base resin 14 can be freely changed by adjusting extrusion amounts from the extruders 11, 12. With the configuration and method, as a result of merging the additional resin 13 in a portion with the lowest flow velocity which is the merging section 24 obtained during the circumferential spread of the base resin 14 inside the annular flow channel 3, a difference in flow velocity distribution inside the crosshead unit 1 is reduced and a resin replacement time is shortened compared with when using a configuration in which a resin is supplied to the crosshead unit 1 with only one extruder. With the configuration and method, as a result of merging the additional resin 13 in a portion with the lowest flow velocity which is the merging section 24 obtained during the circumferential spread of the base resin 14 inside the annular flow channel 3, a difference in flow velocity distribution inside the crosshead unit 1 is reduced and parison thickness unevenness in the circumferential direction is decreased compared with when using a configuration in which a resin is supplied to the crosshead unit 1 with only one extruder. With the configuration and method, the additional resin extruder 11 and the base resin extruder 12 are connected to the annular flow channel 3 at positions which are arranged opposite each other with an angular separation of 180 degrees. With the configuration and method, a plurality of the annular flow channels 3 is formed concentrically, a plurality of the additional resin extruders 11, 11A and a plurality of the base resin extruders 12, 12A, 12B are connected to the crosshead unit 1, and the parison 9 having the base layer 14a formed as multiple layers and the additional layer 13a formed in the linear shape as multiple layers is obtained. With the configuration and method, when the multilayer parison 9 is formed using a plurality of annular flow channels 3 provided in the crosshead unit 1, an insertion angle θ of the additional resin 13 in the annular flow channels 3 can be freely changed by changing an attachment angle, on the circumference of the annular flow channels 3, of sleeves 22, 22A, 22B provided between housings 2, 2A, 2B and an inner core 4 of the crosshead unit 1. With the configuration and method, end surfaces 13c, 13d of the additional layer 13a of the additional resin 13 formed within the insertion angle θ are, in a cross-sectional view, in a direction same as a radial direction of the parison 9, inner side portions 13M and outer side portions 13N of the end surfaces 13c, 13d match an inner circumferential surface 14M and an outer circumferential surface 14N of the base layer 14a of the base resin 14 of the parison 9, and the additional layer 13a is not present in the base layer 14a outside the end surfaces 13c, 13d of the additional layer 13a.

### INDUSTRIAL APPLICABILITY

In the molding machine crosshead and the parison forming method using the same in accordance with the present invention, the additional resin is not limited to an electrically conductive resin and can be a transparent resin or a colored resin, and the molded articles are not limited to pipes and can be containers of various types.

1-18. (canceled)

19. A molding machine crosshead which uses at least one additional resin extruder (11) and at least one base resin extruder (12) that are connected to at least one annular flow channel (3) of a crosshead unit (1) at mutually different angular positions and which is configured to form a parison (9) by adding an additional layer (13a) constituted by an additional resin (13) from the additional resin extruder (11) to a base layer (14a) constituted by a base resin (14) supplied from the base resin extruder (12) into the annular flow channel (3), the additional resin (13) being a material different from the base resin (14), wherein the additional resin (13) is formed in a linear shape along a longitudinal direction of the parison (9) as part of the parison (9) by forming a merging section (24) of the additional resin (13) in a merging portion obtained during a circumferential spread of the base resin (14) inside the annular flow channel (3).

20. The molding machine crosshead according to claim 19, wherein the additional resin (13) is an electrically conductive resin.

21. The molding machine crosshead according to claim 19, wherein an insertion angle (θ), on a circumference inside the annular flow channel (3), of the additional resin (13) into the base resin (14) can be freely changed by adjusting extrusion amounts from the extruders (11, 12).

22. The molding machine crosshead according to claim 20, wherein an insertion angle (θ), on a circumference inside the annular flow channel (3), of the additional resin (13) into the base resin (14) can be freely changed by adjusting extrusion amounts from the extruders (11, 12).

23. The molding machine crosshead according to claim 19, wherein as a result of merging the additional resin (13) in a portion with a lowest flow velocity which is the merging section (24) obtained during the circumferential spread of the base resin (14) inside the annular flow channel (3), a difference in flow velocity distribution inside the crosshead unit (1) is reduced and a resin replacement time is shortened compared with when using a configuration in which a resin is supplied to the crosshead unit (1) with only one extruder.

24. The molding machine crosshead according to claim 20, wherein as a result of merging the additional resin (13) in a portion with a lowest flow velocity which is the merging section (24) obtained during the circumferential spread of the base resin (14) inside the annular flow channel (3), a difference in flow velocity distribution inside the crosshead unit (1) is reduced and a resin replacement time is shortened compared with when using a configuration in which a resin is supplied to the crosshead unit (1) with only one extruder.

25. The molding machine crosshead according to claim 21, wherein as a result of merging the additional resin (13) in a portion with a lowest flow velocity which is the merging section (24) obtained during the circumferential spread of the base resin (14) inside the annular flow channel (3), a difference in flow velocity distribution inside the crosshead unit (1) is reduced and a resin replacement time is shortened compared with when using a configuration in which a resin is supplied to the crosshead unit (1) with only one extruder.

26. The molding machine crosshead according to claim 19, wherein as a result of merging the additional resin (13) in a portion with a lowest flow velocity which is the merging section (24) obtained during the circumferential spread of the base resin (14) inside the annular flow channel (3), a difference in flow velocity distribution inside the crosshead unit (1) is reduced and parison thickness unevenness in the circumferential direction is decreased compared with when using a configuration in which a resin is supplied to the crosshead unit (1) with only one extruder.

27. The molding machine crosshead according to claim 20, wherein as a result of merging the additional resin (13) in a portion with a lowest flow velocity which is the merging section (24) obtained during the circumferential spread of the base resin (14) inside the annular flow channel (3), a difference in flow velocity distribution inside the crosshead unit (1) is reduced and parison thickness unevenness in the circumferential direction is decreased compared with when using a configuration in which a resin is supplied to the crosshead unit (1) with only one extruder.

28. The molding machine crosshead according to claim 21, wherein as a result of merging the additional resin (13) in a portion with a lowest flow velocity which is the merging section (24) obtained during the circumferential spread of the base resin (14) inside the annular flow channel (3), a difference in flow velocity distribution inside the crosshead unit (1) is reduced and parison thickness unevenness in the circumferential direction is decreased compared with when using a configuration in which a resin is supplied to the crosshead unit (1) with only one extruder.

29. The molding machine crosshead according to claim 19, wherein the additional resin extruder (11) and the base resin extruder (12) are connected to the annular flow channel (3) at positions which are arranged opposite each other with an angular separation of 180 degrees.

30. The molding machine crosshead according to claim 20, wherein the additional resin extruder (11) and the base resin extruder (12) are connected to the annular flow channel (3) at positions which are arranged opposite each other with an angular separation of 180 degrees.

31. The molding machine crosshead according to claim 21, wherein the additional resin extruder (11) and the base resin extruder (12) are connected to the annular flow channel (3) at positions which are arranged opposite each other with an angular separation of 180 degrees.

32. The molding machine crosshead according to claim 23, wherein the additional resin extruder (11) and the base resin extruder (12) are connected to the annular flow channel (3) at positions which are arranged opposite each other with an angular separation of 180 degrees.

33. The molding machine crosshead according to claim 26, wherein the additional resin extruder (11) and the base resin extruder (12) are connected to the annular flow channel (3) at positions which are arranged opposite each other with an angular separation of 180 degrees.

34. The molding machine crosshead according to claim 19, wherein a plurality of the annular flow channels (3) is formed concentrically, a plurality of the additional resin extruders (11, 11A) and a plurality of the base resin extruders (12, 12A, 12B) are connected to the crosshead unit (1), and the parison (9) having the base layer (14a) formed as multiple layers and the additional layer (13a) formed in the linear shape as multiple layers is obtained.

35. The molding machine crosshead according to claim 34, wherein when the multilayer parison (9) is formed using the plurality of annular flow channels (3) provided in the crosshead unit (1), an insertion angle (θ) of the additional resin (13) in the annular flow channels (3) can be freely changed by changing an attachment angle, on the circumference of the annular flow channels (3), of sleeves (22, 22A, 22B) provided between housings (2, 2A, 2B) and an inner core (4) of the crosshead unit (1).

36. The molding machine crosshead according to claim 35, wherein end surfaces (13c, 13d) of the additional layer (13a) of the additional resin (13) formed within the insertion angle (θ) are, in a cross-sectional view, in a direction same as a radial direction of the parison 9, inner side portions (13M) and outer side portions (13N) of the end surfaces (13c, 13d) match an inner circumferential surface (14M) and an outer circumferential surface (14N) of the base layer (14a) of the base resin (14) of the parison (9), and the additional layer (13a) is not present in the base layer (14a) outside the end surfaces (13c, 13d) of the additional layer (13a).

37. A parison manufacturing method using a molding machine crosshead which uses at least one additional resin extruder (11) and at least one base resin extruder (12) that are connected to at least one annular flow channel (3) of a crosshead unit (1) at mutually different angular positions and which is configured to form a parison (9) by adding an additional layer (13a) constituted by an additional resin (13) from the additional resin extruder (11) to a base layer (14a) constituted by a base resin (14) supplied from the base resin extruder (12) into the annular flow channel (3), the additional resin (13) being a material different from the base resin (14), the method comprising:
forming the additional resin (13) in a linear shape along a longitudinal direction of the parison (9) as part of the parison (9) by forming a merging section (24) of the additional resin (13) in a merging portion obtained during a circumferential spread of the base resin (14) inside the annular flow channel (3).

38. The parison manufacturing method using a molding machine crosshead according to claim 37, wherein the additional resin (13) is an electrically conductive resin.

39. The parison manufacturing method using a molding machine crosshead according to claim 37, wherein an insertion angle (θ), on a circumference inside the annular flow channel (3), of the additional resin (13) into the base resin (14) can be freely changed by adjusting extrusion amounts from the extruders (11, 12).

40. The parison manufacturing method using a molding machine crosshead according to claim 38, wherein an insertion angle (θ), on a circumference inside the annular flow channel (3), of the additional resin (13) into the base resin (14) can be freely changed by adjusting extrusion amounts from the extruders (11, 12).

41. The parison manufacturing method using a molding machine crosshead according to claim 37, wherein as a result of merging the additional resin (13) in a portion with a lowest flow velocity which is the merging section (24) obtained during the circumferential spread of the base resin (14) inside the annular flow channel (3), a difference in flow velocity distribution inside the crosshead unit (1) is reduced and a resin replacement time is shortened compared with when using a configuration in which a resin is supplied to the crosshead unit (1) with only one extruder.

42. The parison manufacturing method using a molding machine crosshead according to claim 38, wherein as a result of merging the additional resin (13) in a portion with a lowest flow velocity which is the merging section (24) obtained during the circumferential spread of the base resin (14) inside the annular flow channel (3), a difference in flow velocity distribution inside the crosshead unit (1) is reduced and a resin replacement time is shortened compared with when using a configuration in which a resin is supplied to the crosshead unit (1) with only one extruder.

43. The parison manufacturing method using a molding machine crosshead according to claim 39, wherein as a result of merging the additional resin (13) in a portion with a lowest flow velocity which is the merging section (24) obtained during the circumferential spread of the base resin (14) inside the annular flow channel (3), a difference in flow velocity distribution inside the crosshead unit (1) is reduced and a resin replacement time is shortened compared with when using a configuration in which a resin is supplied to the crosshead unit (1) with only one extruder.

44. The parison manufacturing method using a molding machine crosshead according to claim 37, wherein as a result of merging the additional resin (13) in a portion with a lowest flow velocity which is the merging section (24) obtained during the circumferential spread of the base resin (14) inside the annular flow channel (3), a difference in flow velocity distribution inside the crosshead unit (1) is reduced and parison thickness unevenness in the circumferential direction is decreased compared with when using a configuration in which a resin is supplied to the crosshead unit (1) with only one extruder.

45. The parison manufacturing method using a molding machine crosshead according to claim 38, wherein as a result of merging the additional resin (13) in a portion with a lowest flow velocity which is the merging section (24) obtained during the circumferential spread of the base resin (14) inside the annular flow channel (3), a difference in flow velocity distribution inside the crosshead unit (1) is reduced and parison thickness unevenness in the circumferential direction is decreased compared with when using a configuration in which a resin is supplied to the crosshead unit (1) with only one extruder.

46. The parison manufacturing method using a molding machine crosshead according to claim 39, wherein as a result of merging the additional resin (13) in a portion with a lowest flow velocity which is the merging section (24) obtained during the circumferential spread of the base resin (14) inside the annular flow channel (3), a difference in flow velocity distribution inside the crosshead unit (1) is reduced and parison thickness unevenness in the circumferential direction is decreased compared with when using a configuration in which a resin is supplied to the crosshead unit (1) with only one extruder.

47. The parison manufacturing method using a molding machine crosshead according to claim 37, wherein the additional resin extruder (11) and the base resin extruder (12) are connected to the annular flow channel (3) at positions which are arranged opposite each other with an angular separation of 180 degrees.

48. The parison manufacturing method using a molding machine crosshead according to claim 38, wherein the additional resin extruder (11) and the base resin extruder (12) are connected to the annular flow channel (3) at positions which are arranged opposite each other with an angular separation of 180 degrees.

49. The parison manufacturing method using a molding machine crosshead according to claim 39, wherein the additional resin extruder (11) and the base resin extruder (12) are connected to the annular flow channel (3) at positions which are arranged opposite each other with an angular separation of 180 degrees.

50. The parison manufacturing method using a molding machine crosshead according to claim 41, wherein the additional resin extruder (11) and the base resin extruder (12) are connected to the annular flow channel (3) at positions which are arranged opposite each other with an angular separation of 180 degrees.

51. The parison manufacturing method using a molding machine crosshead according to claim 44, wherein the additional resin extruder (11) and the base resin extruder (12) are connected to the annular flow channel (3) at positions which are arranged opposite each other with an angular separation of 180 degrees.

52. The parison manufacturing method using a molding machine crosshead according to claim 37, wherein a plurality of the annular flow channels (3) is formed concentrically, a plurality of the additional resin extruders (11, 11A) and a plurality of the base resin extruders (12, 12A, 12B) are connected to the crosshead unit (1), and the parison (9) having the base layer (14a) formed as multiple layers and the additional layer (13a) formed in the linear shape as multiple layers is obtained.

53. The parison manufacturing method using a molding machine crosshead according to claim 47, wherein when the multilayer parison (9) is formed using a plurality of annular flow channels (3) provided in the crosshead unit (1), an insertion angle (θ) of the additional resin (13) in the annular flow channels (3) can be freely changed by changing an attachment angle, on the circumference of the annular flow channels (3), of sleeves (22, 22A, 22B) provided between housings (2, 2A, 2B) and an inner core (4) of the crosshead unit (1).

54. The parison manufacturing method using a molding machine crosshead according to claim 53, wherein end surfaces (13c, 13d) of the additional layer (13a) of the additional resin (13) formed within the insertion angle (θ) are, in a cross-sectional view, in a direction same as a radial direction of the parison 9, inner side portions (13M) and outer side portions (13N) of the end surfaces (13c, 13d) match an inner circumferential surface (14M) and an outer circumferential surface (14N) of the base layer (14a) of the base resin (14) of the parison (9), and the additional layer (13a) is not present in the base layer (14a) outside the end surfaces (13c, 13d) of the additional layer (13a).
